(19) United States
(12) Patent Application Publication
(10) Pub. No.: US 2024/0378019 A1
(43) Pub. Date: Nov. 14, 2024

(54) FLASH-BASED AI ACCELERATOR

(71) Applicant: ANAFLASH INC., Sunnyvale, CA (US)

(72) Inventors: Sihwan Kim, San Francisco, CA (US); Seung-Hwan Song, Palo Alto, CA (US)

(21) Appl. No.: 18/660,200

(22) Filed: May 9, 2024

Related U.S. Application Data
(60) Provisional application No. 63/466,115, filed on May 12, 2023.
(60) Provisional application No. 63/603,122, filed on Nov. 28, 2023.

(51) Int. Cl. G06F 7/523; G06F 7/50; G06F 12/02

(52) U.S. Cl. CPC G06F 7/523; G06F 7/50; G06F 12/0246

(57) ABSTRACT

A computing apparatus comprises a host circuit; and a computing device that includes a memory device for facilitating a neural network, the computing device configured to: read weight values from respective non-volatile memory cells in the memory device by biasing the non-volatile memory cells; perform a multiplication and accumulation calculation on the non-volatile memory cells using the read weight value; and output a result of the multiplication and calculation operation to the host system.

### CROSS-REFERENCE TO RELATED APPLICATIONS

This application is a non-provisional application of provisional application U.S. 63/466,115, filed May 12, 2023, entitled “Flash Based AI Accelerator” and claims the benefit of provisional application U.S. 63/603,122, filed Nov. 28, 2023, entitled “Computing device having a non-volatile weight memory”.

### TECHNICAL FIELD

The embodiments described herein relate to non-volatile memory (NVM) devices, particularly to methods and apparatus for implementing deep learning neural networks within flash memory arrays.

### BACKGROUND

Artificial neural networks are increasingly used in artificial intelligence and machine learning applications. An artificial neural network generates an output by propagating inputs through one or more intermediate layers. The layers connecting the input to the output are connected by sets of weights that are generated in a training or learning phase by determining a set of mathematical manipulations to turn the input into the output, calculating the probability of each output as it moves through the layers. When the weights have been established, they can be used in the inference phase to determine the output.

Although such neural networks can provide highly accurate results, they are extremely computationally intensive, resulting in a lot of data transfers when reading the weights connecting the layers out of memory and transferring them into the computing units of a processing unit. In some embodiments of the present invention, deep learning neural networks are implemented on memory devices controlled by a data controller to minimize data transfer associated with reading neural network weights.

### SUMMARY OF INVENTION

In one embodiment, a computing apparatus comprises a host circuit; and, a computing device that includes a memory device for facilitating a neural network operation, the computing device configured to: read weight values from respective non-volatile memory cells in the memory device by biasing the non-volatile memory cells; perform a multiplication and accumulation calculation on the non-volatile memory cells using the read weight value; and output a final result of the multiplication and calculation operation to the host system.

In another embodiment, the host circuit comprises: a host processor providing instructions to the computing device for transferring data between the host component and the computing device; and a dynamic random-access memory (DRAM) used by the host processor for storing data and program instructions to run the computing apparatus.

In another embodiment, the computing device further comprises: a memory controller communicating with the host processor and commanding to retrieve data from the memory device; and a dynamic random access memory (DRAM) coupled to the memory controller, wherein the memory device comprises a plurality of computing non-volatile memory (NVM) components, each computing non-volatile memory component comprising: an array of non-volatile memory cells; a word line driving circuitry comprising a plurality of word line driving circuits, the driving circuitry to bias the non-volatile memory cells; a source line circuitry comprising a plurality of source line circuits, the source line circuitry configured to send input signals to the non-volatile memory cells and receive output signals from the non-volatile memory cells through respective source lines for the multiplication and accumulation calculation operation on the non-volatile memory cells; and a bit line circuit configured to send input signals to the non-volatile memory cells and receive output signals from the memory cells through respective bit lines for the multiplication and accumulation calculation operation on the non-volatile memory cells.

In another embodiment, each of the source line circuit and the bit line circuit comprises: four switching circuits arranged in two pairs, each in parallel, and two switched in each pair are in series; a driving circuit between a first of the two pairs of switching circuits; a sensing circuit between a second of the two pairs of switching circuits; and a buffer coupled to the two pairs of switching circuits.

In another embodiment, the two parallel switching circuits have a first common node coupled to the buffer and a second common node coupled to the nonvolatile memory array.

In another embodiment, the memory controller is further configured to control operations of the source line circuit and the bit line circuit.

In another embodiment, the memory controller is further configured to control a two-way data transfer between the source line circuit and the non-volatile memory cells through respective source lines and a two-way data transfer between the bit line circuit and the non-volatile memory cells through respective bit lines.

In another embodiment, the memory device comprises: an array of non-volatile memory cells; a word line driving circuitry to bias the non-volatile memory cells; a source line driving circuitry configured to ground the memory cells; a bit line sensing circuitry configured to receive and sense output signals from the memory cells; and a computing unit coupled to the bit line sensing circuit, wherein the computing unit is configured to perform a multiplication and accumulation calculation operation based on the read weight values from the non-volatile memory cells, wherein the read weight values are represented by digital values.

In another embodiment, the computing unit is configured to receive input values from a memory controller communicating with the host circuit and read weight values from respective non-volatile memory cells to perform the multiplication and accumulation calculation.

In another embodiment, the weight values from the non-volatile memory cells comprises floating point weight values.

In another embodiment, the computing apparatus is configured to: quantize the floating-point weight values according to a predefined quantization method; program the non-volatile memory cells with quantized weight values, respectively, and verify the programmed flash memory cells with preset read reference voltages.

In another embodiment, the computing apparatus is further configured to quantize the floating-point weight values based on a unified mapping range.

In another embodiment, the computing apparatus is further configured to quantize the floating-point weight values based on a unified number of non-volatile memory cells.

In another embodiment, the computing device further comprises: a computing processor that is located outside the memory device, the computing device is configured to perform a multiplication and accumulation calculation on the computing processor based on the read weight values from the non-volatile memory cells, wherein the read weight values are represented by digital values.

In another embodiment, the computing apparatus is further configured to: quantize the floating-point weight values according to a predefined quantization method; program non-volatile memory cells with quantized weight values, respectively, and verify the programmed flash memory cells with preset read reference voltages.

In another embodiment, the computing apparatus is further configured to quantize the floating-point weight values based on a unified mapping range.

In another embodiment, the computing apparatus is further configured to quantize the floating-point weight values based on a unified number of non-volatile memory cells.

In one embodiment, a method comprising: receiving AI machine learning analog data from a pre-trained neural network; quantize the analog data with floating point data based on a unified mapping range; programming the non-volatile memory cells with quantized data values; and reading the flash memory cells with read reference voltages.

In another embodiment, the read reference voltage is set halfway between a first threshold voltage range of first programmed memory cells and a second threshold voltage range of second programmed memory cells, the second programmed state being adjacent to the first programmed state.

In one embodiment, a method comprising: receiving AI machine learning analog data from a pre-trained neural network; quantize the analog data with floating point data based on a unified number of non-volatile memory cells in an array; programming the non-volatile memory cells with quantized data values; and reading the flash memory cells with read reference voltages.

### BRIEF DESCRIPTION OF THE DRAWINGS

FIG. 1 shows a schematic representation of a conventional array of NAND-configured memory cells.

FIG. 2 shows a graphical representation of a neural network model according to one embodiment.

FIGS. 3A and 3B illustrate graphical and mathematical representations of neural network operations.

FIG. 4 is a schematic block diagram of a computing system including Flash AI Accelerator in accordance with one embodiment of the present invention.

FIG. 5 is a schematic block diagram of Flash AI Accelerator according to a first embodiment of the present invention.

FIGS. 6A, 6B, and 6C are circuit diagrams of a first embodiment of a computing NAND Flash in accordance with the present invention.

FIG. 7 is a flowchart of sequential MAC calculations of the Flash AI Accelerator according to an embodiment of the present invention.

FIG. 8 is a circuit diagram of a second embodiment of the Computing system for a NAND flash memory array according to the present invention.

FIG. 9 is a schematic block diagram of the computing system according to a third embodiment of the present invention.

FIG. 10 is a flowchart of a method of quantizing parameters of a neural network according to an embodiment of the present invention.

FIGS. 11A and 11B show exemplary weight distributions of programmed memory cells and respective memory cell distributions according to some embodiments of the present invention.

FIG. 12A is a flowchart of a simple weight sensing method according to an embodiment of the present invention.

FIG. 12B is a flowchart of a power efficient weight sensing method according to an embodiment of the present invention.

FIG. 13A is a diagram illustrating multiple states of the memory cells according to one embodiment and FIG. 13B is a table respective results responding to multiple read reference voltage applied to the memory cells.

FIGS. 14A, 14B, and 14C show circuit diagrams of the sensing and driving circuits for two-way data transfer.

### DETAILED DESCRIPTION

In the following detailed description of the invention, reference is made to the accompanying drawings that form a part hereof, and in which is shown, by way of illustration, specific embodiment. In the drawings, like numerals Features of the present invention will become apparent to those skilled in the art from the following description regarding the drawings. Understanding that the drawings depict only typical embodiments of the invention and are not, therefore, to be considered limiting in scope, the invention will be described with additional specificity and detail through the use of the accompanying drawings.

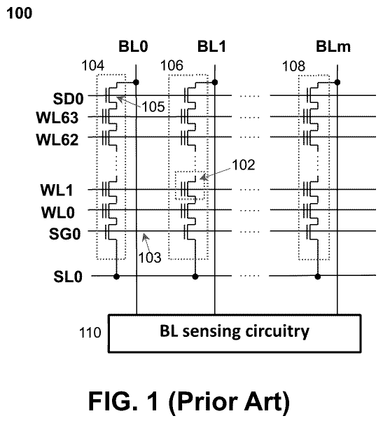

FIG. 1 shows a schematic representation of a conventional array of NAND-configured memory cells.

The memory array 100 shown in FIG. 1 comprises an array of non-volatile memory cells 102 (e.g., floating gate memory cells) arranged in columns such as series strings 104, 106 and 108. Each cell is coupled drain to source in each series string 104, 106 and 108. An access line (e.g., word line) WL0-WL63 that spans across multiple series strings 104, 106, 108 is coupled to the control gates of each memory cell in a row to bias the control gates of the memory cells in the row.

Bit lines BL0, BL1, . . . . BLm are coupled to the series strings and eventually coupled to BL sensing circuitry 110 which typically comprise sense devices (e.g., sense amplifiers) that detect the state of each cell by sensing current or voltage on a selected bit line.

Each series string 104, 106, 108 of memory cells is coupled to a source line SL0 by a source select transistor connected to SG0 through the transistor's gate and to the bit line BL0, BL1, and BLm by a drain select transistor connected to SD0 through the transistor's gate.

The source select transistors are controlled by a source select gate control line SG0 (103) coupled to their control gates. The drain select transistors are controlled by a drain select gate control line SD0 (105).

In a typical programming of the memory array 100, each memory cell is individually programmed as either a single level cell (SLC) or a multiple level cell (MLC). The cell's threshold voltage (Vₜₕ) can be used as an indication of the data stored in the cell.

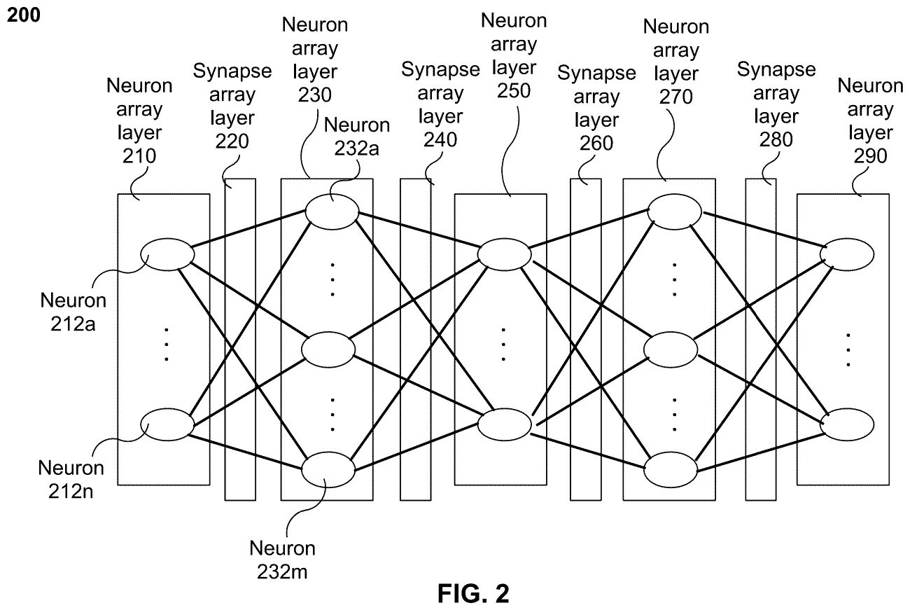

FIG. 2 shows a graphical representation of a neural network model.

As depicted, the neural network 200 may include five neuron array layers (or shortly, neuron layers) 210, 230, 250, 270 and 290, and synapse array layers (or shortly, synapse layers) 220, 240, 260 and 280. Each of the neuron layers (e.g., 210) may include a suitable number of neurons. In FIG. 2, only five neuron layers and four synapse layers are shown. However, it should be apparent to those of ordinary skill in the art that the neural network 200 may include other suitable numbers of neuron layers and a synapse layer may be disposed between two adjacent neuron layers.

It is noted that each neuron (e.g., 212a) in a neuron layer (e.g., 210) may be connected to one or more of the neurons (e.g., 232a-232m) in the next neuron array layer (e.g., 230) through m synapses in a synapse layer (e.g., 220). For instance, if each of the neurons in neuron layer 210 is electrically coupled to all the neurons in neuron layer 230, synapse layer 220 may include n×m synapses. In embodiments, each synapse may have a trainable weight parameter (w) that describes the connection strength between two neurons.

In embodiments, the relationship between input neuron signals (Ain) and output neuron signals (Aout) may be described by an activation function with the following equation:

Aout=f(Ain)=W×Ain+Bias (1)

where, Ain and Aout are matrices representing input signals to a synapse layer and output signals from the synapse layer, respectively, W is a matrix representing the weights of the synapse layer, and Bias is a matrix representing the bias signals for Aout. In embodiments, W and Bias may be trainable parameters and stored in a logic-friendly non-volatile memory (NVM). For instance, a training/machine learning process may be used with known data to determine W and Bias. In embodiments, the function f may be a nonlinear function, such as sigmoid, tanh, ReLU, leaky ReLU, etc.

By way of example, the relationship described in equation (1) may be illustrated for neuron layer 210 having two neurons, synapse layer 220, and neuron layer 230 having three neurons. In this example, Ain representing output signals from the neuron array layer 210 may be expressed as a matrix of 2 rows by 1 column; Aout representing output signals from the synapse layer 220 may be expressed as a matrix of 3 rows by 1 column; W representing the weights of the synapse layer 220 may be expressed as a matrix of 3 rows by 2 columns, having six weight values; and Bias representing bias values added to the neuron layer 230 may be expressed as a 3 rows by 1 column matrix. A nonlinear function f applied to each element of (W×Ain+Bias) in equation (1) may determine the final values of each element of Aout. By way of another example, the neuron array layer 210 may receive input signals from sensors and the neuron array layer 290 may represent response signals.

In some embodiments, there may be numerous neurons and synapses in the neural network 200, and matrix multiplication and summation in equation (1) may be a process that may consume a large amount of computing resources. In conventional processing-in-memory computing approaches, a computing device performs the matrix multiplication within an NVM cell array using analog electrical values rather than using the digital logic and arithmetic components. These conventional designs aim to reduce the computational load and reduce power requirements by reducing the communication between CMOS logic and NVM components. These conventional approaches, however, are prone to have large variations in current input signals to each synapse because of large parasitic resistance on the current input signal path in a large-scale NVM cell array. Also, sneak currents through half-selected cells in a large array change the programmed resistance values, resulting in unwanted program disturbance and degradation of neural network computation accuracy.

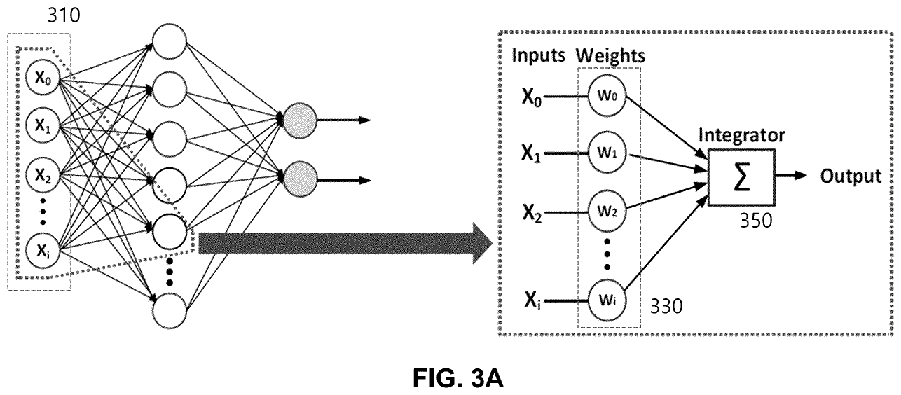

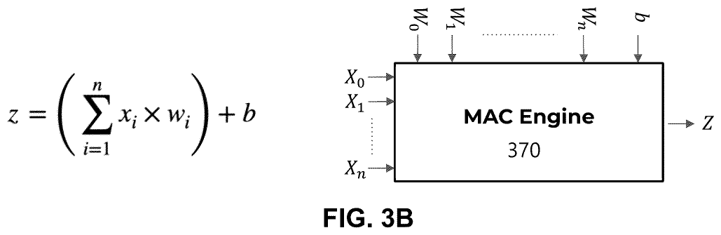

FIGS. 3A and 3B illustrate graphical and mathematical representations of neural network operations.

FIG. 3A shows a building block of an artificial neural network.

An input layer 310 consists of X₀, . . . , Xᵢ. representing inputs that the neuron receives from the external sensory system or from other neurons with which it has a connection. Neuron nodes (X₀˜Xᵢ) in the input layer do not perform any computations. They simply pass the input values to the neurons in the first hidden layer. The inputs can represent a form of a voltage, a current, or a particular data value (e.g., binary digits), for example. The inputs X₀˜Xᵢ from the previous nodes are multiplied with the weights W₀˜Wᵢ from the synapse layer 330.

The hidden layers of the network consist of interconnected neurons that perform computations on the input data. Each neuron in a hidden layer receives inputs X₀˜Xᵢ from all neurons in the previous layer. The inputs are multiplied by corresponding weights, W₀, . . . , Wᵢ. The weights determine how much influence the input from one neuron has on the output of another. Then, those element-wise multiplication results are summated in the integrator 350 and provide an output value.

The output layer of the network produces the final predictions or outputs of the network. Depending on the tasks being performed (e.g., binary classification, multi-class classification, regression), the output layer contains different numbers of neurons. Neurons in the output layer receive input from neurons in the last hidden layer and apply activation functions. The activation function created by this layer is usually different from that used in hidden layers. The final output value or prediction is a result of this activation function.

FIG. 3B shows a mathematical equation and a computing engine 370 of such a MAC operation for n inputs and n weights to generate the output z (after adding additional bias term b).

In the equation, Z denotes a weighted Sum, n denotes the total number of input connections, Wᵢ denotes the weight for the i-th input, and Xᵢ denotes the i-th input value. b denotes a bias that provides an additional input to the neuron, allowing it to adjust its output threshold. For each neuron in a hidden layer or the output layer, the weighted sum of its inputs is computed. That is, for each layer, the weight, W₁ through Wₙ, of each of the neurons in the layer is multiplied by a corresponding input value, X₁ through Xₙ, for the neuron, the values of this intermediate computation are summed together. This is the MAC operation, which multiplies individual W and individual input values and then accumulates (i.e., sums) the results. The appropriate bias value b is then added to the MAC operation for generating an output Z, as shown in FIG. 3B.

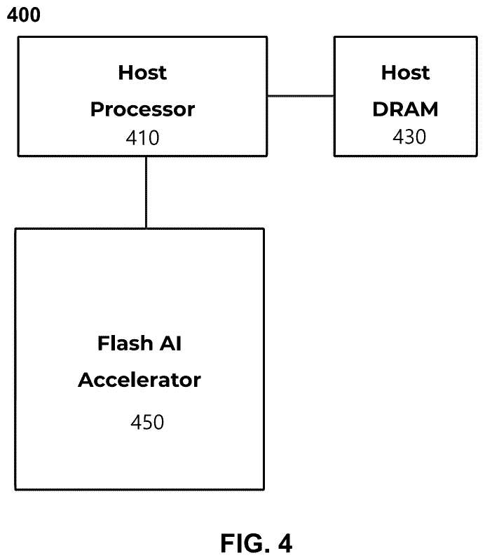

FIG. 4 illustrates a computing system 400 in accordance with an embodiment of the present invention.

The computing System comprises a host system and Flash AI accelerator 450.

In the present example, the host system comprises a host processor 410 and a host Dynamic Random Access Memory (DRAM) 430. A computing system is configured so that data related to MAC calculations can be maintained persistently while in power-down mode, and weight data can be computed within the flash AI accelerator 450 without moving the data to the host processor.

The host DRAM is the host system's physical memory and can be DRAM, SRAM, nonvolatile memory or another type of storage.

The host processor may use the host DRAM to store data, program instructions, or any other kind of information. The host processor can be a type of processor, such as an application processor (AP), a microcontroller unit (MCU), a central processing unit (CPU), or a graphic processing unit (GPU). The host processor communicates with the AI accelerator using a host bus, in which case the interface is omitted. The Host Processor controls the main system, but it takes too much load, so the Flash AI Accelerator distributes the load to the Flash Controller.

Flash AI Accelerator is connected to the host processor via an interface, such as PCI Express (PCIe). Flash AI Accelerator is configured to calculate MAC equations for each neural network layer using the stored weight parameter information without sending the weight data to the host system. A neural network layer's intermediate result doesn't necessarily have to be sent to the host processor and the host DRAM through the host processor, according to some embodiments of the present invention.

With the present invention, data traffic between flash AI accelerators and host processors and between host processors and host memory can be significantly reduced when neural network layers must be computed in large amounts. Additionally, the host DRAM capacity can be minimized to maintain only data required by the host processor.

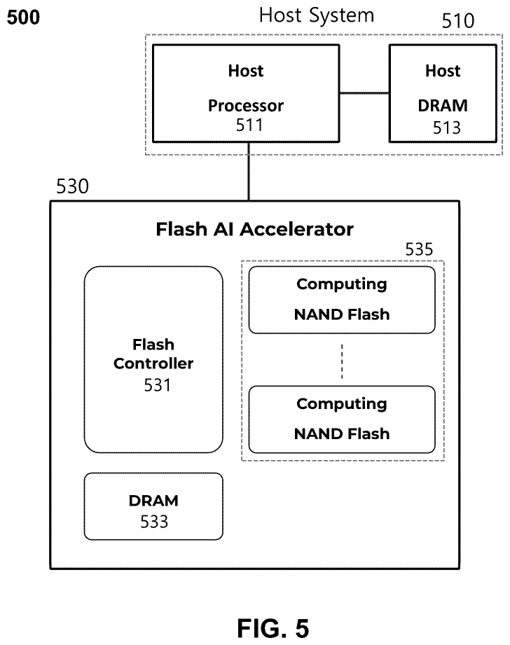

FIG. 5 illustrates a computing system in accordance with a first embodiment of the present invention.

The computing system 500 comprises a host system 510 and Flash AI accelerator 530.

This section does not repeat the technical details of the host processor 511 and host DRAM 513 described in FIG. 4.

The Flash AI Accelerator can implement the technology proposed herein, where the neural network inputs or other data are received from the host processor. Depending on the embodiment, the inputs can be received from the host processor and then provided to the computing NAND Flash devices 535. When applied to AI deep learning processes, these inputs can be used to generate an output result using the weighted inputs into corresponding neural network layers. Once the weights are determined, they can be stored in NAND flash memory devices for later use, where the storage of these weights in NAND flash is discussed in further detail below.

Flash AI Accelerator is connected to the host processor via an interface, such as PCI Express (PCIe) and comprises (1) Flash controller 531, (2) DRAM 533, and (3) Computing NAND Flash devices 535.

A flash controller 531 oversees the entire operation of the Flash AI Accelerator 530. Thus, the computing NAND Flash 535 and DRAM 533 operate in accordance with commands from Flash controller 531. The Flash controller 531 may comprise (1) a computing unit (ALU) for managing the data from both the DRAM and the flash memory circuit and (2) a plurality of static random access-memory (SRAM). Flash controllers can be the types of processors, such as an application processor (AP), a microcontroller unit (MCU), a central processing unit (CPU), or a graphic processing unit (GPU). Flash controller may further comprise a first SRAM for receiving data of the set of NAND flash memories in the AI accelerator and a second SRAM that is configured to accept data from the DRAM.

DRAM 533 is a local memory of the Flash AI Accelerator 530.

In one embodiment, the computing NAND Flash devices 535 perform independently for computing neural networks with trained weights stored in the flash memory cells and for the program-verify/read the nonvolatile memory cell. This operation reduces the load on the Host Processor 511 by communicating only essential information and prevents excessive data volume from flowing back and forth, resulting in a bottleneck.

In some embodiments, the computing NAND Flash devices include non-volatile memory of NAND Flash cells, although any other suitable memory type, such as NOR and Charge Trap Flash (CTF) cells, phase change RAM (PRAM, also referred to as Phase Change Memory-PCM), Nitride Read Only Memory (NROM), Ferroelectric RAM (FRAM) and/or magnetic RAM (MRAM) can also be used.

The charge levels stored in the flash memory cells and/or the analog voltages or currents written into and read out of the cells are referred to herein collectively as analog values or storage values. Although the embodiments described herein mainly address threshold voltages, the methods and systems described herein may be used with any other suitable kind of storage value.

Once the computing system is powered up, computing NAND flash calculates MAC equations of each neural network layer with the stored weight parameter information in the computing NAND flash without sending the raw data to the flash controller.

Intermediate result of the neural network layers doesn't necessarily be sent to the host processor through the flash controller. Therefore, the data traffic between computing NAND

Flash devices and host processors and between the host processor and host DRAM can be reduced significantly when the computational requirement for neural network layers is large. The required host DRAM capacity can also be minimized by maintaining only data required by the host processor.

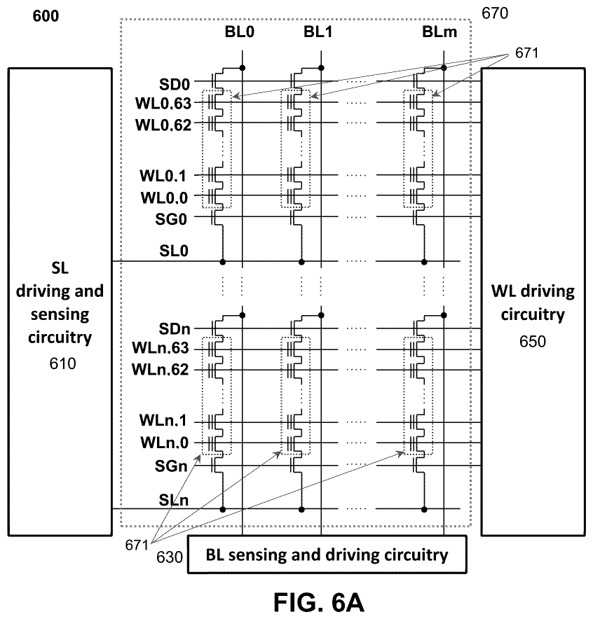

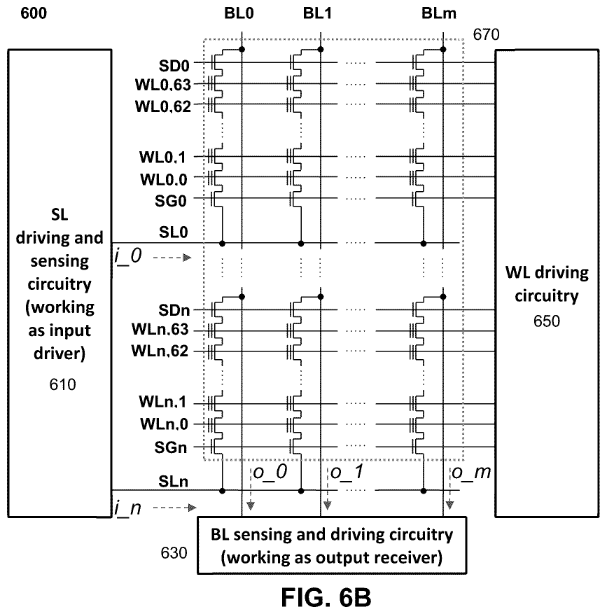

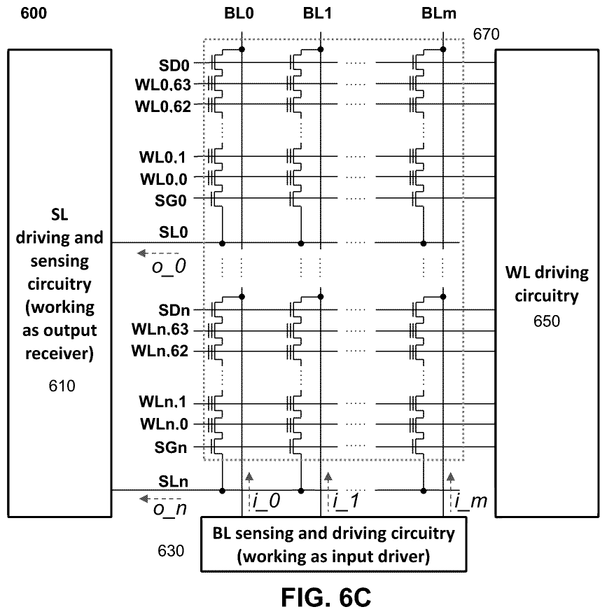

FIGS. 6A-6C illustrate a computing NAND flash memory device for neural network operations according to a first embodiment of the present invention.

The computing NAND flash memory device 600 in FIG. 6A includes a SL driving and sensing circuitry 610, a BL sensing and driving circuitry 630, a WL driving circuitry 650, and a NAND Flash array 670 interconnecting these circuitries. For purposes of clarity by way of example not limitation, it should be understood that the NAND flash array is organized in blocks with multiple pages per block, and the details of the two-dimensional or three-dimensional NAND flash array are not described for the purpose of clarity.

The SL driving and sensing circuitry 610 comprises a plurality of source line drivers for outputting output signals and source line buffers (not shown) storing for respective data received.

The SL driving and sensing circuitry 610 may further comprise SL line buffers (not shown) to store data representative of particular voltages to be applied to source lines SL0, . . . , SLn. The SL driving and sensing circuitry 610 is configured to generate and apply specific voltages to respective source lines SL0 through SLn based on the data stored in the respective source line buffers.

In one embodiment, the SL driving and sensing circuitry 610 may also comprise source line buffers (not shown) configured to store specific data values (e.g., bits) representing a current and/or voltage sensed on the SL lines.

In one embodiment, the SL driving and sensing circuitry 610 further comprises a plurality of sensors sensing output signals, i.e., currents and/or voltages on the source lines, SL0, . . . , SLn, for example. The sensed signal, for instance, is the sum of currents flow through the N-number selected memory cells along the SL lines when read voltages are applied to bias selected memory cells via the respective word lines WL0_63, . . . , WLx_XX, . . . , WLn_0. Therefore, the current and/or voltages sensed on SL lines depend on the word line bias applied to the selected memory cells and the respective data state of each memory cell.

For implementing two-way data transfer, the SL driving and sensing circuitry 610 may further comprise an input/output interface (e.g., bi-directional, not shown) for transmitting and receiving data into and out of the circuitry in one embodiment of the present invention.

An interface may include a multi-signal bus, for example.

The BL sensing and driving circuitry 630 comprises a plurality of sensors to sense specific output currents and/or voltages on respective bit lines, BL0, BL1, . . . , BLm, for example.

For implementing two-way data transfer, the BL sensing and driving circuitry 630 can further comprise one or more buffers (not shown) to store specific data values (e.g., bits), representing a current and/or voltage sensed on the bit lines in one embodiment of the present invention.

The BL sensing and driving circuitry 630 may further comprise bit line buffers (not shown) configured to store data representative of particular voltages to be applied to bit lines BL0, . . . , BLm during the operation of the computing NAND flash memory device 600, for example.

In one embodiment, the BL sensing and driving circuitry 630 further comprises bit line drivers (not shown) to apply particular voltages to the bit lines, BL0, BL1, . . . , BLm, such as responsive to data stored in bit line buffers during operation of the computing NAND flash memory device.

The BL sensing and driving circuitry 630 may further comprise an input/output interface (e.g., bidirectional) for transmitting and receiving data into and out of the circuitry. The interface may include a multi-signal bus, for example. Input signals on the bit lines might comprise discrete signals (e.g., logic high, logic low) or might comprise analog signals, such as a particular voltage within a specific range of voltages, for example. In a 5V system, the input signals might either be 0V or 5V in a digital representation, whereas the input signals might be any voltage from 0V to 5V in an analog system, for example.

The WL driving circuitry 650 may comprise word line drivers configured to generate and apply particular voltages to the word lines, such as responsive to data stored in the word line register (not shown), during the operation of the NAND flash device. The word line (not numbered) that spans across multiple series strings BL0, BL1, . . . , BLm is coupled to the control gates of each memory cell in a row in order to bias the control gates of the memory cells (not numbered) in the row.

Input signals on SL lines and word lines might comprise discrete signals (e.g., logic high, logic low) or might comprise analog signals, such as a particular voltage within a certain range of voltages, for example. In a 5V system, the input signals might either be 0V or 5V in a digital representation, whereas the input signals might be any voltage from 0V to 5V in an analog system, for example.

The NAND Flash array 670 comprises a plurality of memory blocks 671, and each of the plurality of the memory blocks may include a plurality of non-volatile memory cells. These non-volatile memory cells are coupled between a bit line BL0, BL1, . . . . BLm and a source line SL0, . . . SLn. Each string comprises 64 memory cells, although various embodiments are not limited to 64 memory cells per string.

Each bit line BL0, BL1, . . . . BLm is coupled to the BL sensing and driving circuitry 630, respectively. Each NAND string connecting the BL line and the SL line has an upper select transistor connected to the drain select gate control line SD0, . . . . SDn, flash cell transistors connected to WLs, and a lower select transistor connected to SG.

The memory cells in the memory block 671 between the upper select transistor and the lower select transistor can be the charge storage memory cells, for example.

The SL line is shared across multiple NAND strings through the lower select transistor connected to the source select gate control lines SG0, . . . , SGn.

The BL line is shared across the multiple NAND strings through the upper select transistor connected to the drain select gate control lines SD0, . . . , SDn.

FIG. 6B illustrates a first-mode of two-way data transfers for MAC calculation in the computing NAND flash memory device according to one embodiment of the present invention.

The first round MAC calculation using the strings of the NAND Flash array 670 in FIG. 6B corresponds to the neural network operation among the three layers in neural network architecture 200: neuron array layer 210 (an input layer), synapse layer 220 (an intermediate layer), and neuron array layer 230 (an output layer) in FIG. 2.

Referring back to FIG. 2, an input stage of the first round MAC calculation refers to the condition in which (1) the neuron-model nodes 212a, . . . , 212n, in neuron array layer 210, have respective input signal values, respectively, (2) each channel across the synapse array layer 220 is loaded with preset weights before MAC operations begin.

### Input Stage

Referring back to FIG. 2, for the first round MAC operations, the neuron-modeled nodes 212a, . . . , and 212n in the neuron array layer 210 are loaded with input signal values, respectively.

Accordingly, the memory cells in the strings within the computing NAND flash are programmed to have threshold voltages (Vₜₕ) that indicate the data stored in the memory cell. The stored data corresponds to the set of weight values (e.g., 1, w2, w3 . . . ) loaded onto each synapse array layer 220, 240, 260, and 280 in the neural network in FIG. 2, for example. The loaded weights might have been individually programmed as either single-level cells (SLCs) or multiple-level cells (MLCs) during a previous program/write operation of the memory device.

### MAC Calculation Stage

The SL driving and sensing circuitry 610 supplies specified input signals to the memory cells of the specific strings through respective source lines SL0, . . . , SLn, for example.

The WL driving circuitry 650 supplies a suitable voltage to the selected memory cells before a layer matrix multiplication, allowing input signals, which are equivalent to the input values carried by the neuron-modeled nodes 212a, . . . , 212n, in neuron array layer 210, to be multiplied by the weight values stored by the memory cells, which are equivalent to the weight parameters assigned to channels in the synapse array layer 220.

The memory cells operative by the selective input signal from WL driving circuitry 650 output the output signal via respective bit lines, respectively. The output signals on the bit lines BL0, BL1, . . . , BLm are equivalent to the outputs from the matrix multiplication between the inputs X0, X1, X2, . . . . Xi carried by neuron-modeled nodes 212a, 212n and the respective weight parameters W0, W1, W2, . . . , Wn assigned to channels of the synapse array layer 220 in FIG. 2.

### Output Stage

After completing the sensing of the output signals (resulting from the first MAC operation) from bit lines BL0 through BLm, the BL sensing and driving circuitry 630 stores the output signals (resulting from the first MAC operation) to use them as input signals for implementing a pending second MAC operation.

FIG. 6C illustrates a second-mode of two-way data transfers for MAC calculation in the computing NAND flash memory device according to one embodiment of the present invention.

The second round MAC calculation using the strings of the NAND Flash array 670 in FIG. 6C corresponds to the neural network operation among the three layers in neural network architecture 200: neuron array layer 230 (an input layer), synapse layer 240 (an intermediate layer), and neuron array layer 250 (output layer) in FIG. 2.

### Input Stage

Referring back to FIG. 2, before the second round MAC calculation, all channels across the synapse array layer 240 are loaded with their respective preset weights. As previously described in FIG. 6B, the loaded weights in FIG. 2 might have been individually programmed as either single-level cells (SLCs) or multiple-level cells (MLCs) during a previous program/write operation of the memory device.

Memory cells are programmed to have threshold voltages (Vth) that indicate the data stored in the memory cell. The data can correspond to the set of weight values (w1, w2, w3 . . . ) loaded onto each synapse array layer 220, 240, 260, and 280 in the neural network in FIG. 2, for example. These programmed memory cells may have weight values different from previously programmed weight values stored in the memory cells for the first MAC calculation.

### Second Round MAC Calculation

The BL sensing and driving circuitry 630 supplies input signals, i_0, i_1, . . . , i_m, those are the stored output signals from the first MAC operation through the respective bit lines BL0, BL1 . . . , BLm, for example.

The WL driving circuitry 650 supplies a suitable voltage to the selected memory cells prior to a layer matrix multiplication, allowing input signals, which are equivalent to the input values carried by the neuron-modeled nodes 232a, . . . , 232m, in neuron array layer 230, to be multiplied by the weight values stored by the memory cells, which are equivalent to the weight parameters assigned to channels in the synapse array layer 240. These memory cells activated in the second round MAC calculation operation may be different from the memory cells activated in the first round MAC calculation operation.

The memory cells operative by the selective input signal from WL driving circuitry 650 output the output signal via respective SL lines, respectively. The output signals on the SL lines are equivalent to the outputs from the matrix multiplication between the inputs X0, X1, X2, . . . . Xi carried by neuron-modeled nodes 232a, . . . , 232 m, and weight parameters W0, W1, W2, . . . . Wi assigned to channels of the synapse array layer 240, respectively, as shown in FIG. 2.

### Output Stage

After completing the sensing of the output signals (resulting from the second MAC operation) through sensing lines SL0 through SLn, SL driving and sensing circuitry 610 stores the output signals (resulting from the second MAC operation) to use them as input signals for implementing the following a third round MAC calculation, for example.

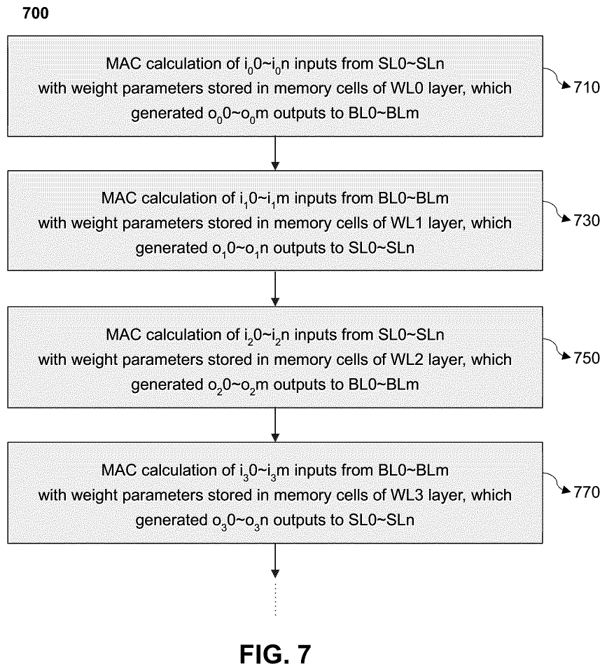

FIG. 7 is a flowchart 700 of sequential MAC operations by two-way data transfers for MAC calculation in the computing NAND flash memory according to one embodiment of the present invention. The two-way data transfer is implemented within the Computing NAND Flash without going through the Flash Controller and the Host system in FIG. 5.

### 1st Round MAC Calculation (Step 710)

In Step 710, a first-round MAC operation is performed between neuron model nodes in the neuron array layer 210 and the channels of synapse array layer 220 in FIG. 2

### Input Stage

The memory cells of the strings are programmed to have threshold voltages (Vth) that indicate the data stored in the memory cell. The stored data corresponds to the set of weight values (w1, w2, w3 . . . ) loaded onto each synapse array layer 220, 240, 260, and 280 in the neural network in FIG. 2, for example. These memory cells may have different weight values stored by previous programming, for example. The WL driving circuitry supplies a suitable voltage to the selected memory cells prior to a layer matrix multiplication, allowing multiplication of weight values with input signals, which are equivalent to the input values carried by the neuron-modeled nodes 212a, . . . 212n, in neuron array layer 210.

### 1st Round MAC Calculation Stage

The memory cells driven selectively by WL driving circuitry output signals via bit lines BL0-BLm. The output signals on the bit lines represent the results of the matrix multiplication between the inputs X0, X1, X2, . . . . Xi carried by neuron model nodes 212a, . . . 212n, and weight parameters W0, W1, W2, . . . , Wi on the respective channels of the synapse array layer 220.

### Output Stage

The BL sensing and driving circuitry 630 receives a group of output signals (resulting from the first MAC operation) from respective bit lines BL1 through BLm and stores them as input signals to be used for sequential MAC calculation to follow. These stored output signals (values) represent the values of neuron-modeled nodes 232a, . . . 232 m, in neuron array layer 230.

### 2nd Round MAC Calculation (Step 730)

In Step 730, a second-round MAC operation is performed between neuron model nodes in the neuron array layer 230 and channels of synapse array layer 240 in FIG. 2.

### Input Stage

The BL sensing and driving circuitry 630 supplies the stored output signals from the first round MAC calculation to the corresponding memory cells for a layer matrix multiplication through respective bit lines BL0, . . . , BLm, for example. These input signals are equivalent to the input values carried by the neuron-modeled nodes 232a, . . . 232m, in neuron array layer 230.

The WL driving circuitry 650 supplies a suitable voltage to the selected memory cells. Selected memory cells driven by WL driving circuitry output signals for the synapse layer 240 via source lines SL0-SLn with providing the weight values.

### MAC Calculation Stage

The output signals on the SL lines represent the results of the matrix multiplication between the inputs X0, X1, X2, . . . . Xi carried by neuron model nodes 232a, . . . 232m, and weight parameters W0, W1, W2, . . . . Wi on the respective channels of the synapse array layer 240.

### Output Stage

The SL driving and sensing circuitry 610 receives a group of output signals (resulting from the second MAC operation) through respective SL lines SL0˜SLn and stores them as input signals to be used for sequential MAC calculation to follow. These stored output signals (values) represent the values of neuron-modeled nodes in the Neuron array layer 250.

### 3th Round MAC Calculation (Step 750)

In step 750, a third-round MAC operation is performed between neuron model nodes in the neuron array layer 250 and channels of synapse array layer 260 in FIG. 2.

### Input Stage

The SL driving and sensing circuitry 610 supplies the stored output from the second-round calculation to the selected memory cells for a layer matrix multiplication through respective source lines SL0, . . . , SLn, for example. These input signals are equivalent to the input values carried by the neuron-modeled nodes neuron array layer 250. The WL driving circuitry 650 supplies a suitable voltage to the selected memory cells. Selected memory cells driven by WL driving circuitry output signals for the synapse layer 260 via bit lines BL0-BLm with providing the weight values.

### MAC Calculation Stage

The output signals on the BL lines represent the results of the matrix multiplication between the inputs X0, X1, X2 . . . . Xi that are represented by neuron model nodes in neuron array layer 250 and weight parameters W0, W1, W2, . . . . Wi on the respective channels of the synapse array layer 260.

### Output Stage

The BL sensing and driving circuitry 630 receives a group of output signals (resulting from the third MAC operation) through respective BL lines BL0˜BLm and stores them as input signals to be used for sequential MAC calculation to follow. These stored output signals (values) represent the values of neuron-modeled nodes in the Neuron array layer 270.

### 4th Round MAC Calculation (Step 770)

In step 770, a fourth-round MAC operation is performed between neuron model nodes in the neuron array layer 270 and channels of synapse array layer 280 in FIG. 2.

### Input Stage

The BL sensing and driving circuitry 630 supplies the stored output signals from the third round MAC calculation to the corresponding memory cells for a layer matrix multiplication through respective bit lines BL0, . . . , BLm, for example.

These input signals are equivalent to the input values represented by the neuron-modeled nodes in the neuron array layer 270. The WL driving circuitry 650 supplies a suitable voltage to the selected memory cells. Selected memory cells driven by WL driving circuitry output signals for the synapse layer 280 via bit lines BL0-BLm with providing the weight values.

### MAC Calculation Stage

The output signals on the SL lines represent the results of the matrix multiplication between the inputs X0, X1, X2 . . . , Xi represented by neuron model nodes in the Neuron array layer 270 and the weight parameters W0, W1, W2 . . . . Wi on the respective channels of the synapse array layer 280.

### Output Stage

The SL driving and sensing circuitry 610 receives a group of output signals (resulting from the fourth MAC operation) through respective SL lines SL0˜SLn and stores them as input signals to be used for sequential MAC calculation to follow. These stored output signals (values) represent the values of neuron-modeled nodes in the Neuron array layer 290.

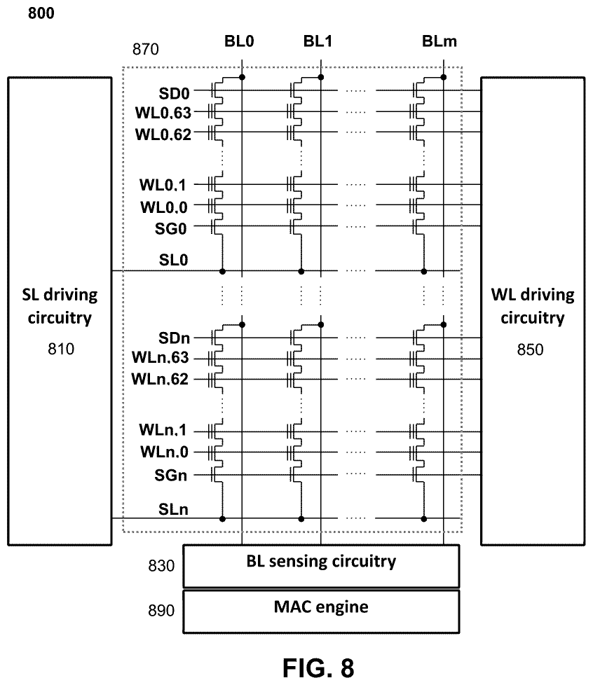

FIG. 8 shows a circuit diagram of a second embodiment of the computing NAND flash memory device according to the present invention.

For purposes of clarity by way of example not limitation, it should be understood that the NAND flash array is organized in blocks with multiple pages per block, and the details of the three-dimensional NAND flash array are not described for the purpose of clarity.

In light of the MAC equation in FIG. 3B, the flash controller 531 outside the computing NAND flash memory device 800 is configured to operate to supply input signals consisting of X₁ through Xₙ to the MAC engine 890. The computing NAND flash memory device 800 comprises SL driving circuitry 810, BL sensing circuitry 830 and a MAC engine 890, a WL driving circuitry 850, and a plurality of string cells 870 interconnecting the three circuits in a NAND flash array.

The SL driving circuitry 810 comprises a plurality of source line circuits coupled to respective source lines SL0, . . . , and SLn, each configured to supply ground on SL lines in response to instructions from the flash controller 531. With the ground on SL lines, the weight values of memory cells in NAND flash array 870 could be sensed in BL sensing circuitry 830 and calculated in MAC engine 890.

The BL sensing circuitry 830 is configured to measure the weights of the cells within a plurality of BL lines in parallel in response to WL input signals on WL.

The WL driving circuitry 850 comprises a plurality of world line circuits coupled to respective word lines, each being configured to apply particular voltages to the word lines such that selected memory cells generate their data stored therein during the operation of the NAND flash device. More precisely, these voltages are supplied to bias their corresponding memory cells through the respective word lines (not numbered) that span across the multiple series strings BL0, BL1, . . . , BLm.

A NAND flash array 870 described herein is identical to the NAND Flash Array 670 in FIG. 6, so it will not be repeated. The memory cells in the NAND flash store a second operand group consisting of W₁ through Wₙ, representing weight parameters previously programmed by WL driving circuitry.

The MAC engine 890 is configured to receive input values x0, x1, . . . , xn from the flash controller 531 and weight values W0, W1, . . . , and Wn from the BL sensing circuitry 830.

The MAC engine 890 comprises a plurality of multiplication and accumulation engines, each of which is configured to perform a multiply and accumulate (MAC) operation of, for example, an input value x0, x1, . . . , xn and a weight value W0, W1, . . . , and Wn in FIG. 3A. The MAC engine 890 may further comprise parallel summation circuits to sum the multiplied products and adders to add the biased weight to the summed product, as recited in the equation in FIG. 3B.

In addition, the MAC engine 890 multiplies each memory cell's weight value with its corresponding input value from the Flash Controller 531. The MAC engine generates the multiplication operation outputs based on the input values x0, x1 . . . , xn and weight values W0, W1 . . . , and Wn. Moreover, the input values, x0, x1, . . . , xn from the flash controller 531 can be digital values, and the weight values stored in the memory cells can be digital values.

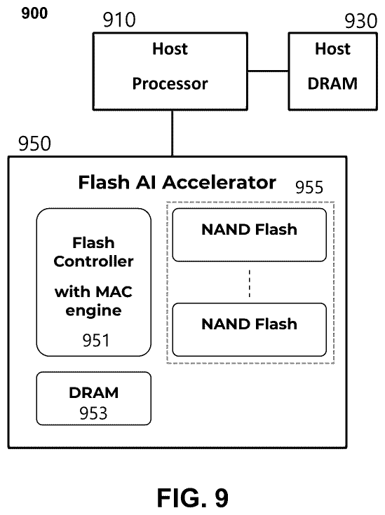

FIG. 9 shows a computing system 900 for quantizing the weights of a neural network in accordance with an embodiment of the present invention.

The technical details of the Host processor 910 and Host DRAM 930 in the computing system 900 are described in FIG. 5 and will not be repeated herein.

The Flash AI Accelerator 950 is connected to the host processor via an interface, such as PCI Express (PCIe) and comprises (1) a Flash controller with MAC engine 951, (2) DRAM 953, and (3) a plurality of NAND Flash devices 955. The Flash AI Accelerator 950 may be a solid state device SSD. However, the various disclosed embodiments are not necessarily limited to an SSD application/implementation. For example, the disclosed NAND flash die and associated processing components can be implemented as part of a package that includes other processing circuitry and/or components.

The Flash Controller with MAC engine 951 oversees the entire operation of the Flash AI Accelerator block. The controller receives commands from the Host processor and performs the commands to transfer data between the host system and the NAND Flash memory packages. Furthermore, the controller may manage reading from and writing to the DRAM for performing various functions and to maintain and manage cached information stored in the DRAM.

The Flash controller with MAC engine 951 is configured to perform independently for computing neural networks with trained weights stored in the array of nonvolatile memory cells and for verifying/reading the array of programmed nonvolatile memory cells in the NAND flash packages. Thus, the Flash controller reduces the load on the host processor by communicating only essential information and prevents excessive data volume from flowing back and forth, resulting in a bottleneck.

The Flash controller with MAC engine 951 may include any type of processing device, such as a microprocessor, a microcontroller, an embedded controller, a logic circuit, software, firmware, or the like, for controlling the operation of the Flash AI Accelerator. The Flash controller may further comprise a first SRAM for receiving data from the set of NAND flash memories in the AI accelerator and a second SRAM that is configured to accept data from the DRAM 953. The controller may include hardware, firmware, software, or any combination thereof that controls a deep-learning neural network for use with the NAND Flash array.

The Flash controller with MAC engine 951 is configured to obtain the weight values, representing individual weights of respective memory cells in the NAND flash memory packages to perform neural network processing. The Flash controller with MAC engine 951 may receive input values from the DRAM 953 for computation of neural networks.

The MAC engine circuit is also configured to multiply the obtained weight value of an individual synapse cell with their corresponding input values of neural network computation to implement the equation in FIG. 3B. The MAC engine may include a set of parallel summation circuits to sum the multiplied products and adders to add the biased weight to the summed product, as recited in the equation in FIG. 3B.

In one embodiment, the Flash controller with MAC engine 951 may be further configured to implement the quantization of a set of floating weight values of the cells.

The Flash controller with MAC engine 951 may be configured to perform the following tasks in some embodiments:
Obtaining channel profile information regarding the final weight values of the floating-point type used in each channel of the pre-trained neural network;
Quantizing a floating-point data according to a determined quantization method;
Programming flash memory cells with quantized data values;
Reading the programmed flash memory cells with preset read reference voltages.

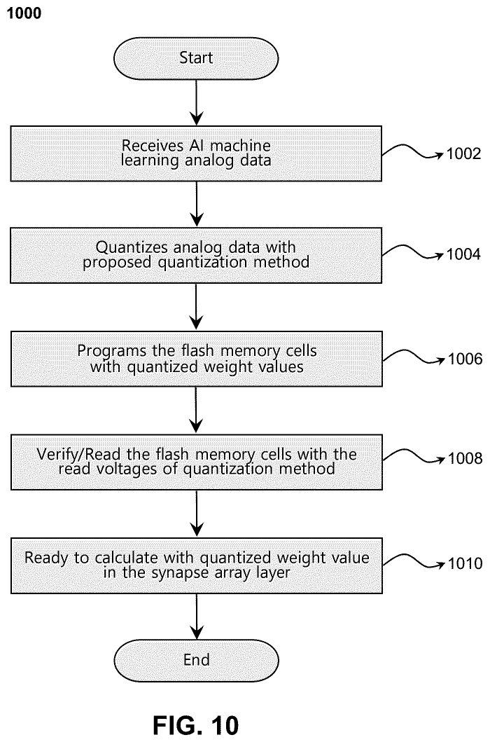

FIG. 10 is a flowchart 1000 of one or more examples of a method of quantizing weight values of synapse array layers. In one embodiment of the present invention, the flash controller with MAC engine 951 is configured to implement the below sequential operations.

### Start

In the beginning step, pre-trained neural network arrays are ready to produce floating-point weight parameters in the channels of the synapse layers.

Receive AI Machine Learning Analog Data from a Pre-Trained Neural Network

In operation step 1002, the channel profile information regarding the final weight values of the floating-point type used in each channel can be obtained.

Before the quantization operation is implemented, a mapping range can be set for these floating-point final weight values. The mapping range, for instance, can be defined as four bits covering 16 multiple states ranging from 0 to 15 for unsigned numbers or −8 to +7 for signed numbers. Using the 16 scale factors (0 through 15 or −8 through +7) to the floating-point weight values, these floating-point weight values are mainly distributed near zero and decrease sharply as they increase to +7 or decrease to −8, resulting in a Gaussian curve centered at zero.

Quantize the Analog Data with Floating Point Data with a Quantization Method Specified

In operation step 1004, the Flash controller with MAC engine 951 can quantize floating-point weight values according to the quantization method specified.

In one embodiment of the present invention, the floating weight values can be quantized according to a unified mapping range specified.

Considering that the unified mapping range is set at 1, the Flash controller with MAC engine 951 can round up floating values that are 0.5 or higher up to 1, but floating values that are less than 0.5 round down to 0. The middle point rounding method is applied to all floating numbers between −8 and 7. Thus, −0.5<x<0.5 floating weight parameters are mapped into 0, and 0.5<x<1.5 x-values are mapped into 1, and 1.5<x<2.5 x-values are mapped into 2, and so on. Quantizing these floating value weights with a unified interval is independent of the density of memory cells for their corresponding integer values.

In another embodiment, the floating weight values can also be quantized according to a unified number of memory cells.

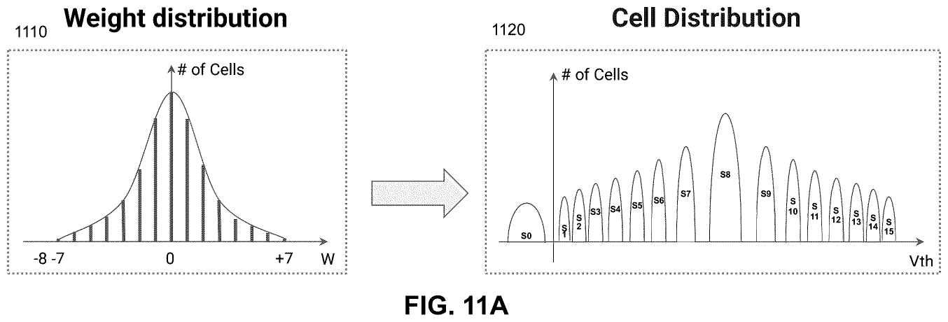

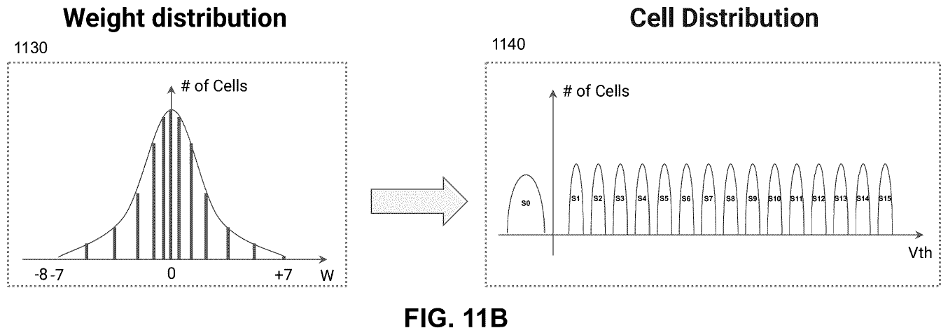

The Flash controller with Mac engine 951 can quantize with a user-defined mapping that maps the given floating values to the user-specified number of digits. It is possible to divide the area where the number of memory cells corresponding to each weight is concentrated into a smaller weight interval and map them accordingly so that the number of memory cells corresponding to each weight is evenly distributed. That is, for example, the x value of −0.2<x<0.2 is 0, the x value of 0.2<x<0.8 is 1, the x value of −0.8<x<−0.2 is −1, and the x value of 0.8<x<1.6 is 2 as shown in FIG. 11B. As a result, the corresponding 16 states will have a uniformly distributed threshold voltage widows and there will be a uniform distribution margin between the 16 states as shown in FIG. 11B.

In another embodiment of the present invention, the floating weight values can be quantized only for a range specified.

When quantizing the corresponding data values (x) and mapping them to the corresponding numbers, only a user-targeting specific interval, such as the interval of m<x<n (the interval of data values greater than m and smaller than n) can be broken into smaller pieces. In the case that a more intensive mapping to a specific range of cell weights increases the accuracy of the artificial intelligence operation (if quantization is done with four bits), only the section m<x<n is divided into 10 weights, and the remaining sections could be evenly divided into 6 weights.

Program the Flashing Memory Cells with Quantized Data Values

In operation step 1006, the memory cells can be programmed with the quantized integer values, respectively. For n-bit multi-level cell NAND flash memory, the threshold voltage of each cell can be programmed to 2\hat{ }n separate states. The cell states are identifiable by corresponding non-overlapping threshold voltage windows, respectively. Further, the cells programmed to have the same state (the same n-bit value) have their threshold voltages fall into the same window, but their exact threshold voltages could be different. Each threshold voltage window is determined by an upper and a lower bound read reference voltage. This distribution of the 2\hat{ }n states is illustrated in FIG. 11A and FIG. 11B as one embodiment of the present invention.

Verify/Read the Flash Memory Cells with Read Reference Voltages

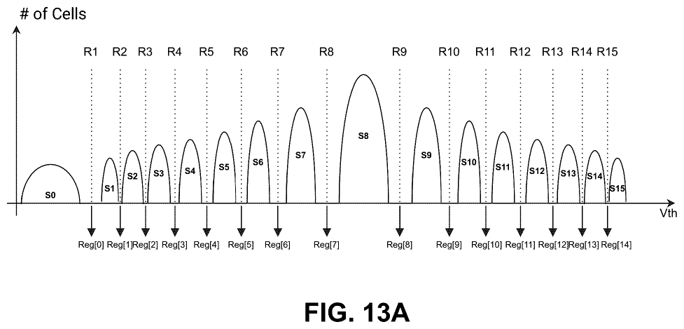

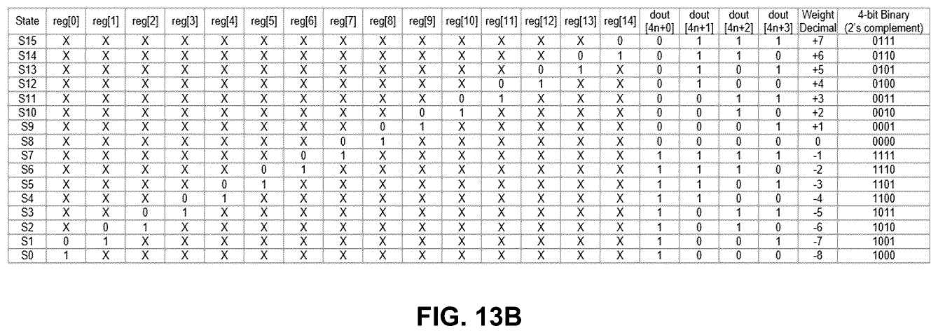

In operation step 1008, the control circuit can read/verify the programmed cells. For an n-bit multi-level NAND flash memory, the controller can use 2\hat{ }n−1 predefined read reference voltages to discriminate between the 2\hat{ }n possible cell states. These read reference voltages are located in between each state of the threshold voltage windows, as shown in FIG. 13.

As part of the read operation, the threshold voltage of the memory cell is compared sequentially to a set of read reference voltages, starting from a low reference voltage and advancing to a high reference voltage, for example. As a result of determining whether the memory cell flows current when the read reference voltage is applied, the stored weight value in n-bits is determined.

Ready to calculate with quantized weight value in the synapse array layer

In operation 1010, currently, the quantized weight values of all the flash memory cells are identified and ready to be calculated with input values from the MAC engine. As shown in FIG. 3A and FIG. 3B, the weight values, W₁ through Wₙ, stored in the memory cells are multiplied by corresponding input values and the identified weight values are ready to be calculated in the synapse array layers 220, 240, 260, and 280 in FIG. 2.

FIGS. 11A and 11B show exemplary weight distributions of programmed memory cells and respective memory cell distributions according to some embodiments of the present invention.

### Quantization of Floating Weight Values Based on a Unified Mapping Range

In FIG. 11A, a unified mapping range is used for quantizing the floating weight values of the memory cells.

In Weight distribution 1110, a symmetrical curve represents the distribution of memory cells corresponding to a range of available threshold voltages. The values of the x-axis of the symmetrical distribution curve represent a set of the floating weight values (W) of the memory cells ranging from −8 to +7. The values on the y-axis of the symmetrical distribution curve represent the number of memory cells corresponding to the floating weight values on the x-axis. Each individual bar area below the symmetrical curve corresponds to the number of memory cells that have floating weights that are proximate to the respective integer values when the floating weights are quantized using a unified mapping range for each individual integer value.

In one embodiment, a constant mapping range can be applied to each integer on the x-axis regardless of the distribution degree of the memory cells. For instance, with a unified mapping range of 1, the floating weight values of −0.5<w<0.5 are mapped into 0, the x value of 0.5<x<1.5 is mapped into 1, the x value of −1.5<w<−0.5 is −1, the x value of 3.5<x<4.5 is mapped into 3, and so on.

As a result, the bar corresponding to 0 is the highest on the y-axis, and the height of the bars decreases as the distance from the value of 0 increases, indicating (1) there are relatively the most memory cells with floating number weights close to the integer 0 and (2) the number of the memory cells that have floating weights close to the respective integer values decreases inversely proportional to the distance from the integer value 0. The majority of memory cells have floating values close to the integer value 0 (−0.5<w<0.5), followed by the memory cells with floating values close to the integer values of 1 (0.5<w<1.5) and −1(−1.5<w<−0.5), and the fewest memory cells store floating values near the integer values of −7 (−7.5<w<−6.5) and 7 (6.5<w<7.5).

Cell distribution 1120 shows how the unified mapping range affects the effective threshold ranges of the quantized memory cells. Each symmetrical curve represents the distributed memory cells corresponding to a range of available threshold voltages.

S1, S2, . . . . S15 denote various states of a memory cell that has been programmed. S0 represents an erase state (not programmed). S1 represents a group of memory cells with quantized values of −7, S2 represents a group of memory cells with quantized values of −6, and S8 represents a group of memory cells with quantized values of 0. The groups of memory cells with quantized values of +3 and +7 are represented by S11 and S15, respectively.

S1, . . . , S15 corresponds to a threshold voltage (Vth) window. That means the memory cells programmed to the same n-bit value (same integer value) have their threshold voltages fall into the same window, but their exact threshold voltages could be different.

Specifically, S8 has the widest threshold voltage window and other states away from S8 have the threshold windows linearly decreasing from S8 threshold voltage window.

Threshold voltages between two adjacent threshold voltage windows of states on the x-axis will be used as read reference voltages to verify/read state of each cell. For each programmed memory cell with any certain state, the read reference voltages that have voltage values of threshold voltages between two adjacent threshold voltage windows of states are applied to the gate of each memory cell to check the flowing current on the memory cell.

A description of the process of verifying/reading memory cells with the read reference voltages is provided by FIGS. 13A and 13B. In the Cell distribution 1120, the y-axis represents the number of memory cells corresponding to the x-axis threshold voltages.

### Quantization of Weight Values Based on a Unified Number of the Memory Cells

In FIG. 11B, the quantization of floating values is mainly based on the uniform number of memory cells, regardless of the density difference between the floating values and their corresponding integer values. In order to quantify the floating weight values of memory cells, only the unified number of memory cells is taken into account.

In the weight distribution 1130, a symmetrical curve represents distributed memory cells corresponding to a range of available threshold voltages.

The values of the x-axis of the symmetrical distribution curve represent a set of the floating weight values of the memory cells ranging from −8 to +7. The values on the y-axis of the symmetrical distribution curve represent the number of memory cells corresponding to the floating weight values on the x-axis. Each individual bar area below the symmetry curve corresponds to the number of memory cells that have floating weights that are proximate to the respective integer values when the floating weights are quantized using a unified number of the memory cells.

In one embodiment, a constant number of the memory cells can be applied to each integer on the x-axis regardless of the distribution degree of the memory cells. That is, as long as the total number of memory cells between two different ranges of floating weight values is the same, then floating weight values from −0.2 to 0.2 can be mapped into 0, floating weight values from 3.2 to 4.8 can be mapped into 4, and floating weight values from −2.8 to −4.2 can be mapped into −3 for example.

The cell distribution 1140 shows how the use of the unified memory cells for the quantization affects the effective threshold ranges of the quantized memory cells.

Each symmetrical curve represents distributed memory cells corresponding to a range of available threshold voltages.

S1, S2, . . . . S15 denote various states of memory cells that have been programmed, respectively. S0 represents an erase state (not programmed), while S1 represents a group of memory cells with quantized values of −7, S2 represents a group of memory cells with quantized values of −6, and S8 represents a group of memory cells with quantized values of 0. The groups of memory cells with quantized values of 3 and 7 are represented by S11 and S15, respectively.

S1, . . . , S15 corresponds to a threshold voltage window. The memory cells programmed to the same n-bit value (same integer value) have their threshold voltages fall into the same window, and their exact threshold voltages could be nearly identical. The number of memory cells with corresponding weight values is evenly distributed, and the range of Vth is equally distributed.

FIG. 11A has already explained that threshold voltages between two adjacent threshold voltage windows of states on the x-axis will serve as read reference voltages for every cell.

This uniform distribution of cell states can prevent the occurrence of excessive peak currents when the cells are operated simultaneously. That is, to ensure the highest performance of the memory device, programming, writing, and reading operations must all occur simultaneously. In this situation, the peak current may exceed the maximum current level allowed by the memory device, resulting in the failure of the memory cell array.

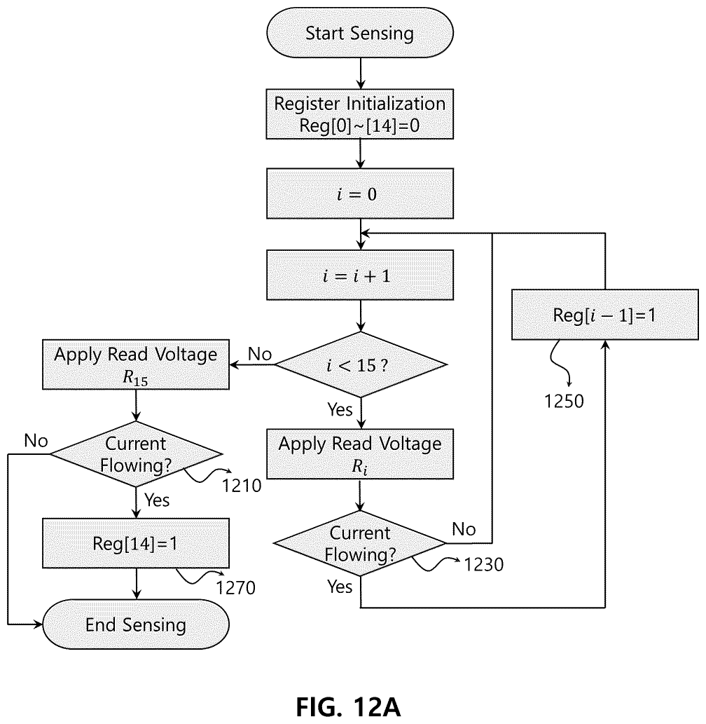

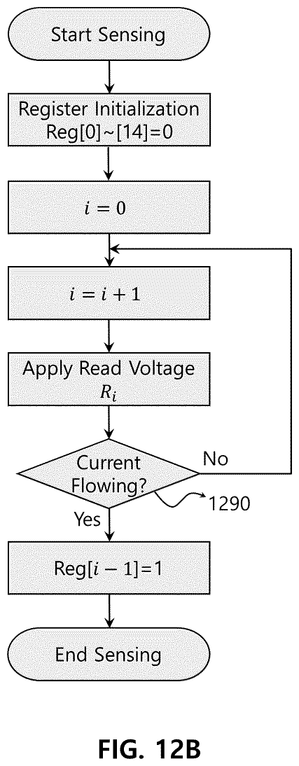

FIG. 12A shows a flowchart of a simple weight sensing method sequentially applying read reference voltages from R1 read stage to R15 read stage.

For each flash memory cell, the read reference voltage is applied to the gate of the transistor of the memory cell and checks the current flowing in step 1210 or 1220. If current flows, ‘1’ is recorded to the corresponding register in step 1230 or 1240, or if not, ‘0’ is recorded to the corresponding register in step 1250 or 1260. The read reference voltage is applied sequentially from R1 to R15, and the registers for all applied read reference voltages are recorded ‘1’ or ‘0’. After applying read reference voltage R15 and recording register, the read reference voltages are sequentially applied to the next flash memory cell from R1 to R15. The state of the flash memory cell indicates the programmed weight value of the memory cell and that can be detected by checking the transition point of the recorded register value from ‘0’ to ‘1’.

FIG. 12B shows a flowchart of a power efficient weight sensing method that once a specific cell's state is identified with current flowing in a certain state in step 1270, the additional sensing operation can be skipped to save power consumption for the cell.

The sequential application of the read reference voltage from R1 to R15 is the same as the case of FIG. 12A. However, when the state of the memory cell is identified with current flowing in step 1270 after applying any certain read reference voltage lower than R15, then stop applying read reference voltage and sensing state of that identified memory cell and start state sensing and sequential applying of the read reference voltage for the next flash memory cell. For example, if the memory cell is identified as S0 state after R1 sensing step, then the sensing operation of the cell in S0 state can be skipped for the following R2˜R15 sensing steps since the state was already identified. Using these skipping sensing steps after state identification, the power consumption of the sensing operation could be saved efficiently.

FIG. 13A show read reference voltages R1˜R15 applied to memory cells for state sensing and FIG. 13B is a table showing register recordings of identified state of memory cells according to one embodiment of the present invention.

The cells with multi-level state (e.g., S8, which indicates a logical bit value of 0) in FIG. 13A have varied threshold voltages that fall into a distinct threshold voltage window. Each symmetrical curve represents the distribution of memory cells corresponding to a range of available threshold voltages.

In the present case, each memory cell is capable of storing 4-bit information as a weight value, covering between −8 decimal to +7 decimal values, namely, −8, −7, −6, . . . , +5, +6, +7. These stored weights with 4-bit binary numbers have their corresponding threshold voltage distributions. The purpose of this classification of the 16 states is to read exemplary 4-bit weight values stored in the multi-level memory cell.

S1, S2, . . . . S15 denote various states of a memory cell that has been programmed. S0 represents an erase state (not programmed), while S1 represents a group of memory cells with quantized values of −7, S2 represents a group of memory cells with quantized values of −6, and S8 represents a group of memory cells with quantized values of 0. The groups of memory cells with quantized values of +3 and +7 are represented by S11 and S15, respectively.

As described already, S1, . . . , S15 corresponds to a threshold voltage (Vth) window. That means the memory cells programmed to the same n-bit value (same integer value) have their threshold voltages fall into the same window (curve), but their exact threshold voltages could be different. Specifically, S8 has the widest threshold voltage window (curve) and other states away from S8 have the threshold windows linearly decreasing from S8 threshold voltage window.

R1, R2, . . . , R15 denote a plurality of read reference voltages to identify the state of each memory cell corresponding to the respective programmed states of S1, S2, . . . . S15. More precisely, R1, R2, . . . , and R15 represent the read voltage applied to the gate of the respective memory cell. As the read reference voltage is applied to the gate of a memory cell, if the applied voltage is greater than the programmed Vth, current will flow through the cell. Current will not flow if the applied voltage is less than programmed Vth.

The symmetrical curves are spaced apart from each other at regular intervals. Therefore, one read reference voltage is used to accurately determine the state of one programmed memory cell corresponding to it.

Further, the spacing between the curves is not uniformly equal, and has a length proportional to the width of the curves forming the spacing. That is, states S0, . . . , S15 are separated by intervals with spacing proportional to the width of the states adjacent to the interval. The gap between adjacent two states becomes wider as memory cells with similar programmed values are densely packed. Comparatively, when the programmed values are relatively loosely packed, their interval is relatively narrow.

More precisely, the state S8 of the memory cell with a programmed value of 0 and its neighboring states S7 and S9 have the longest interval between them, and the interval between other states narrows as they move away from S8. There is an inverse relationship between the narrowness of the interval and the distance from S8 of the corresponding state.

It should be noted that, regardless of the different intervals, the read reference voltages for corresponding states are set to the middle of the interval in one embodiment of the present invention.

Registers [0], [1], . . . and are registers using logic operators 1 and 0 for indicating the 16 states of memory cells respectively.

By applying read voltages ranging from R1 to R15, the presence of current flowing to the corresponding flash memory cell determines whether to write 0 or 1 to the 15 registers. For example, if the stored values of registers Reg[0] ˜Reg[2] are 0 and the values of registers Reg[3] ˜Reg[14] are 1, that means the Vth of the memory cell is higher than the read reference voltage R3 and lower than R4. Thus, the state of that memory cell is S3.

The table in FIG. 13B shows one exemplary case showing how the multi-level states of memory cells S1, S2, . . . . S15 can be read from and stored in their respective registers [0], [1], . . . and [14]. In the table, each individual state S0, . . . , S15 of memory cells is identified by the corresponding register's storing values. For each memory cell, the read reference voltages R1 through R15 are sequentially applied to the gate of the transistor, and the current flow is checked. In the case of current flow, a ‘l’ is recorded to the corresponding register. “0” is recorded immediately before the current flow is checked.

Even after checking in the memory cell's state, a series of read voltages from R1 to R15 are sequentially applied. The registers for all applied read reference voltages are recorded as ‘1’ or ‘0’. “x” represents a don't care term in digital logic. Other than ‘1’ or ‘0, the result of the read voltage input is classified as “x”.

Once read sequential reference voltages R1 to R15 are applied to one memory cell, these read reference voltages R1 to R15 are sequentially applied to the next memory cell. The state of the memory cell indicates its programmed weight value, which can be detected by checking the transition point of the recorded register value from ‘0’ to ‘1’.

Since arithmetic logic such as adder can be simplified when 2's complement is used, the state can be encoded in a 4-bit binary form representing 2's complement number. To retrieve such 4-bit binary information from the cell state, the read reference levels (R1˜R15) can be sequentially applied. Then the transition point changed to 1 can be detected and then translated to 2's complement 4-bit binary number.

If R1 is applied to a gate of a memory device (transistor) and current flows, Reg[0] is written with 1. Alternatively, if a voltage corresponding to R7 is applied to the gate of a memory cell but no current flows, 0 is written to Reg[6].

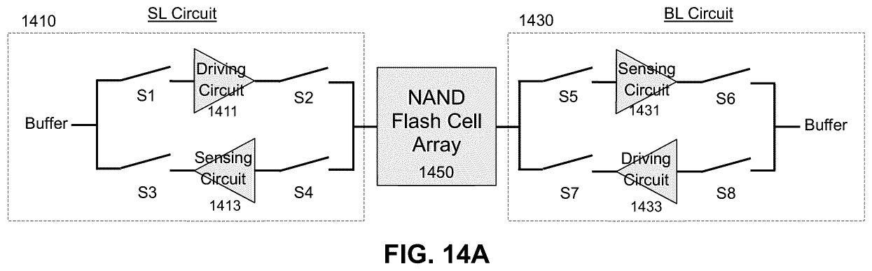

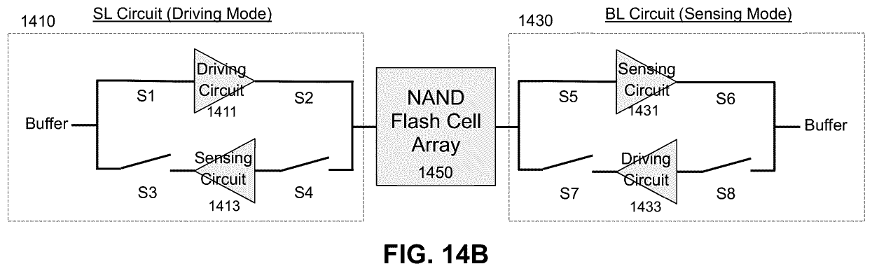

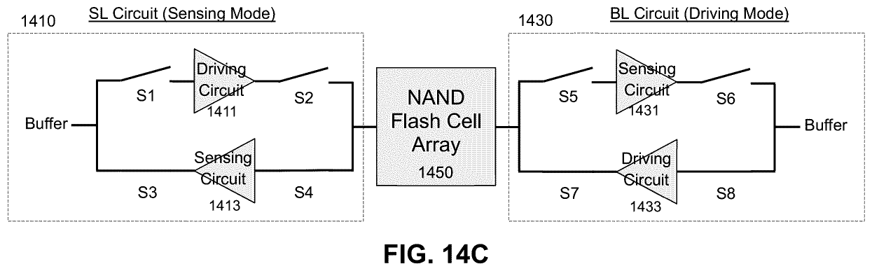

FIG. 14A shows a block diagram of SL circuit and BL circuit in one embodiment of the present invention.

NAND Flash Cell Array 1450 refers to the Nand Flash memory arrays in FIG. 6A. Further, the SL driving and sensing circuitry 610 comprises a plurality of the SL circuits 1410. Also, the BL sensing and driving circuitry 630 comprises a plurality of BL circuits 1430.

A sensing circuit 1413,1431 denotes a sensing circuit embedded in both the SL circuit 1410 and the BL circuit 1430. A driving circuit 1411, 1433 denotes a driving circuit embedded in both the SL driving and sensing circuit and the BL sensing and driving circuit.

SL circuit 1410 and BL circuit 1430 both may include buffers as storage devices for storing values from the sensing circuits and transmitting values to the driving circuits in one embodiment of the present invention.

S1˜S8 denote an electrical switch controlling the openness or closed-ness of both the sensing and driving circuits in one embodiment of the present invention. For example, S1˜S8 allow control over current flow on the SL lines SL0, . . . , SLn and the BL lines BL0, . . . , BLm.

The SL circuit 1410 and the BL circuit 1430 both include (1) a sensing circuit 1413, 1431 adapted to receive values of multiplication and accumulation, arranged in series between S3 and S4 switching circuits and S5 and S6 switching circuits in series; (2) a driving circuit 1411, 1433 adapted to transmit the input-values, arranged in series between S1 and S2 switching circuits and S7 and S8 switching circuits.

The S1 and S3 switching circuits are configured to alternately be turned on and off, while the S2 and S4, S5 and S7, and S6 and S8 switching circuits are also alternately turned on and off in one embodiment of the present invention. With the SL circuit 1410 and the BL circuit 1430 equipped with the sensing circuit 1413,1431 and the driving circuit 1411,1433, the SL driving and sensing circuitry 610 is capable of carrying out two-way data transfer over the respective SL and BL lines.

In FIG. 14B, the SL circuit 1410 is in driving mode, while the BL circuit 1430 is in sensing mode. Alternatively, FIG. 14C shows the case in which the SL circuit 1410 is in sensing mode, while the BL circuit 1430 is in driving mode.

### Sensing Mode

Sensing Mode refers to sensing the current flows on respective SL lines (SL0, . . . , SLn) and the BL lines (BL0, . . . , BLm) from memory cells within the Nand Flash memory arrays in FIG. 6A. A sensing mode is implemented by turning on S3 and S4, or S5 and S6 across the Sensing Circuit simultaneously with turning off S1 and S2, or S7 and S8 across the Driving Circuit. This operation allows the Sensing Circuit to measure the current flowing from the memory cell arrays and store their calculated values while the S1 and S2, or S7 and S8 are simultaneously turned off, preventing the current flow from returning to the non-volatile memory array.

### Driving Mode

Driving Mode refers to enabling the current flows on respective SL lines (SL0, . . . , SLn) and the BL lines (BL0, . . . , BLm) from the buffers to the memory cells within the Nand Flash memory arrays in FIG. 6A.

The Driving mode is implemented by turning on S1 and S2, or S7 and S8 across the Driving Circuit simultaneously with turning off S3 and S4, or S5 and S6. This operation allows the current from the buffers to the non-volatile memory cell arrays, while the S3 and S4, or S5 and S6 are simultaneously turned off, preventing the current flow to the non-volatile memory array.

What is claimed is:

1. A computing apparatus comprising:
a host circuit; and,
a computing device that includes a memory device for facilitating a neural network operation, the computing device configured to:
read weight values from respective non-volatile memory cells in the memory device by biasing the non-volatile memory cells;
perform a multiplication and accumulation calculation on the non-volatile memory cells using the read weight value; and
output a result of the multiplication and calculation to the host system.

2. The computing apparatus of claim 1, wherein the host circuit comprises:
a host processor providing instructions to the computing device for transferring data between the host component and the computing device; and
a dynamic random access memory used by the host processor for storing data and program instructions to run the computing apparatus.

3. The computing apparatus of claim 2, wherein the computing device further comprises:
a memory controller communicating with the host processor and commanding to retrieve data from the memory device; and
a dynamic random access memory coupled to the memory controller,
wherein the memory device comprises a plurality of computing non-volatile memory components, each computing non-volatile memory component comprising:
an array of non-volatile memory cells;
a word line driving circuitry comprising a plurality of word line driving circuits, the driving circuitry to bias the non-volatile memory cells;
a source line circuitry comprising a plurality of source line circuits, the source line circuitry configured to send input signals to the non-volatile memory cells and receive output signals from the non-volatile memory cells through respective source lines for the multiplication and accumulation calculation operation on the non-volatile memory cells; and
a bit line circuit configured to send input signals to the non-volatile memory cells and receive output signals from the memory cells through respective bit lines for the multiplication and accumulation calculation operation on the non-volatile memory cells.

4. The computing apparatus of claim 3, wherein each of the source line circuit and the bit line circuit comprises:
four switching circuits arranged in two pairs, the two pairs being arranged in parallel and each pair of switching circuits having two switching circuits in series;
a driving circuit between the switching circuits of a first pair of the switching circuits;
a sensing circuit between the switching circuits of a second pair of the switching circuits; and
a buffer coupled to the two pairs of switching circuits.

5. The computing apparatus of claim 4, wherein the two parallel switching circuits have a first common node coupled to the buffer and a second common node coupled to the nonvolatile memory array.

6. The computing apparatus of claim 4, wherein the memory controller is further configured to control operations of the source line circuit and the bit line circuit.

7. The computing apparatus of claim 3, said memory controller is further configured to control a two-way data transfer between the source line circuit and the non-volatile memory cells through respective source lines and a two-way data transfer between the bit line circuit and the non-volatile memory cells through respective bit lines.

8. The computing apparatus of claim 1, wherein the memory device comprises:
an array of non-volatile memory cells;
a word line driving circuitry to bias the non-volatile memory cells;
a source line driving circuitry configured to ground the memory cells;
a bit line sensing circuitry configured to receive and sense output signals from the memory cells; and
a computing unit coupled to the bit line sensing circuit, wherein the computing unit is configured to perform a multiplication and accumulation calculation using the read weight values from the non-volatile memory cells, wherein the read weight values are represented by digital values.

9. The computing apparatus of claim 8, wherein the computing unit is configured to (1) receive input values from a memory controller that is configured to communicate with the host circuit and (2) read weight values from respective non-volatile memory cells to perform the multiplication and accumulation calculation.

10. The computing apparatus of claim 9, wherein the weight values from the non-volatile memory cells comprises floating point weight values.

11. The computing apparatus of claim 10, wherein said computing apparatus is configured to:
quantize the floating-point weight values according to a predefined quantization method;
program the non-volatile memory cells with quantized weight values, respectively, and
verify the programmed flash memory cells with preset read reference voltages.

12. The computing apparatus of claim 11, wherein the computing apparatus is further configured to quantize the floating-point weight values based on a unified mapping range.

13. The computing apparatus of claim 12, wherein the computing apparatus is further configured to quantize the floating-point weight values based on a unified number of non-volatile memory cells.

14. The computing apparatus of claim 1, wherein the computing device further comprises a computing processor that is located outside the memory device, wherein the computing processor is configured to perform a multiplication and accumulation calculation using the read weight values from the non-volatile memory cells, wherein the read weight values are represented by digital values.

15. The computing apparatus of claim 14, wherein the computing apparatus is further configured to:
quantize the floating-point weight values according to a predefined quantization method;
program non-volatile memory cells with quantized weight values, respectively, and
verify the programmed flash memory cells with preset read reference voltages.

16. The computing apparatus of claim 15, wherein the computing apparatus is further configured to quantize the floating-point weight values based on a unified mapping range.

17. The computing apparatus of claim 16, wherein the computing apparatus is further configured to quantize the floating-point weight values based on a unified number of non-volatile memory cells.

18. A method, comprising:
receiving AI machine learning analog data from a pre-trained neural network;
quantize the analog data with floating point data based on a unified mapping range;
programming the non-volatile memory cells with quantized data values; and
reading the flash memory cells with read reference voltages.

19. The method of claim 18, the read reference voltage is set halfway between a first threshold voltage range of first programmed memory cells and a second threshold voltage range of second programmed memory cells, the second programmed state being adjacent to the first programmed state.

20. A method, comprising:
receiving AI machine learning analog data from a pre-trained neural network;
quantize the analog data with floating point data based on a unified number of non-volatile memory cells in an array;
programming the non-volatile memory cells with quantized data values; and
reading the flash memory cells with read reference voltages.
